(19) United States
(12) Patent Application Publication
(10) Pub. No.: US 2007/0128534 A1
(43) Pub. Date: Jun. 7, 2007

(54) Liquid Developer and Image Forming Apparatus Using the Same

(75) Inventor: Nobuhiro MIYAKAWA, Suwa-shi, Nagano-ken (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 11/565,862

(22) Filed: Dec. 1, 2006

(30) Foreign Application Priority Data
Dec. 2, 2005 (JP) 2005-349513
Dec. 12, 2005 (JP) 2005-357339

(51) Int. Cl. G03G 9/10

(52) U.S. Cl. 430/115; 430/116

(57) ABSTRACT

A liquid developer includes a vegetable oil, a positively chargeable pigment, and a phosphorous acid ester compound. Here, the vegetable oil contains 30% to 80% by mass of triglyceridic linoleic acid component

### CROSS-REFERENCE TO RELATED APPLICATIONS

This application is based upon and claims the benefit of priority from prior Japanese Patent Application No. 2005-349513, filed Dec. 2, 2005 and No. 2005-357339, filed on Dec. 12, 2005, the entire contents of which are incorporated herein by reference.

### BACKGROUND

1. Technical Field

The present invention relates to a liquid developer used in electro-photographic type image forming apparatuses used in photocopiers, printers and the like, and an image forming apparatus using the same.

2. Related Art

Image forming apparatuses using a liquid developer have a characteristic that even in the case of using fine particles, high-precision images can be formed without causing any problem caused by scattering the particles to the outside of the apparatuses, and the like. In the electro-photographic image forming apparatus using a liquid developer, a developer is used in which colorant particles or a toner containing colorant and resin as a major component is dispersed in a carrier liquid, and an electrostatic latent image formed on a photosensitive member by exposure is developed using the liquid developer.

After the developing, the obtained latent image is transferred and fixed onto a recording medium such as paper or the like, thereby forming-an image.

Liquid developers have been generally using petroleum-based volatile hydrocarbon solvents as the carrier liquid. However, although the volatile hydrocarbon solvents are stable materials with low electric conductivities, it is required to volatilize or evaporate the volatile hydrocarbon solvent of the carrier liquid upon fixing the toner transferred or recorded on the recording medium. When evaporated volatile hydrocarbon solvents are discharged, the solvents would cause environmental contamination.

Thus, to give consideration to the environment of use, it is necessary to provide a recovering device of the carrier liquid which has turned into a gas phase in the vicinity of the fixing apparatus. However, an increase of the size is now indispensable for such image forming apparatuses because of the presence of the recovering device of carrier liquid, and thus it is disadvantageous for the image forming apparatuses to be miniaturized.

Furthermore, it has been also proposed to prevent evaporation or volatilization of the carrier liquid by using non-volatile silicone oil or liquid paraffin as the carrier liquid. However, since the chemical properties of these materials as the carrier liquid are stable, the carrier liquid tends to remain on the recording medium even after the fixing process. As a result, there have been problems that the texture of the printing quality is deteriorated, or the presence of the carrier liquid on the paper surface results in deterioration of impressibility, deterioration of the writing characteristics of writing instruments using water-soluble inks, and the like.

Also, during the manufacturing process for the liquid developers according to the related art, while the respective components are used in a state of being dispersed in a non-aqueous, non-polar solvent as the carrier liquid, the properties of the non-polar solvent would cause problems such as large-sized apparatuses, deterioration of the quality of recorded materials, poor storage stability of the liquid developer, and the like.

Meanwhile, it has been repeatedly proposed to use vegetable oils, instead of volatile hydrocarbon organic solvents, as the carrier liquid. For example, JP-A-2000-19787 suggests that by using vegetable oils as the carrier liquid for liquid developers, an odorless carrier liquid with a small particle size, enhanced image density, resolution, and fixability can be obtained.

In the case of preparing a positively charged liquid developer using a vegetable oil as the carrier liquid, it is essential to use a charge controlling agent (CCA) for the process of positive charging. If the amount of the charge controlling agent used is increased, the storability of the dispersion becomes unstable. In particular, when a liquid-state metal soap is used, there is a tendency that the viscosity of the dispersion is increased upon long-term storage, and it becomes difficult to expect successful accomplishment of the function from the liquid developer.

On the other hand, when vegetable oils are used as the carrier liquid, there is obtained a feature that oxidative polymerization of the unsaturated bonds present in the vegetable oils brings about early-stage stable image formation of the images transferred onto paper, while there is also a problem that occurrence of the oxidative polymerization at a high rate may lead to a decrease in fluidity during storage, and subsequent deterioration of the carrier liquid.

For example, JP-A-2003-335998 suggests adding an antioxidant to a vegetable oil having an oxo value of 100 to 150, for an emulsion ink useful for stencil printing, which uses a vegetable oil as a dispersion medium, and it is suggested to add bisphenol-based antioxidants, sulfur-based antioxidants, phosphite-based antioxidants and the like as the antioxidant for the purpose.

When high productive and available vegetable oil such as soybean oil, corn oil, cottonseed oil, safflower oil, and the like are used for the carrier liquid of liquid developers, the polymerization is promptly carried out upon fixing because above-mentioned vegetable oils have large contents of triglyceridic linoleic acid, which is a divalent unsaturated fatty acid. Subsequently the liquid developers may have good fixability. On the other hand, there are problems such as high viscosity, bad odor, coloration, and the like because of the oxidation when storing or using the liquid developers for a long time.

For the carrier liquid of liquid developers, there has been a demand for the liquid developer having excellent image forming properties, for example, charging properties as well as the properties such as oxidation prevention, polymerization prevention and the like. However, adding antioxidants to carrier liquid have never been examined in relation to the image forming properties and the like.

### SUMMARY

An advantage of some aspects of the invention is to provide a liquid developer for positive charging, containing a vegetable oil as the carrier liquid, which liquid developer has both good storage stability and fixability after transfer to paper or the like, without deteriorating the charging properties of a positively charged polarity of the colorant, which is dispersed in the vegetable oil.

According to an aspect of the invention, there is provided a liquid developer including a positively chargeable pigment, a carrier liquid formed of a vegetable oil, and a phosphorus acid ester compound, wherein the amount of a triglyceridic linoleic acid component in the carrier liquid is 30% to 80% by mass.

The vegetable oil of the liquid developer according to the aspect of the invention may be at least any one of corn oil, soybean oil, cottonseed oil, or safflower oil.

The liquid developer according to the aspect of the invention may contain the phosphorus acid ester compound in an amount of 0.2% to 5.0% by mass.

The liquid developer according to the aspect of the invention may contain at least any one selected from triphenyl phosphite, trioleyl phosphite, diphenyl mono(2-ethylhexyl) phosphite, dilauryl hydrogen phosphite, diphenyl hydrogen phosphite, tetraphenyl tetra(tridecyl)pentaerythritol tetraphosphite, and tetra(C12-C15 alkyl) 4,4′-isopropylidenediphenyl phosphite, as the phosphorus acid ester.

The liquid developer according to the aspect of the invention may contain a phenolic antioxidant in an amount of 0.05% by mass or more and 0.4% by mass or less.

The liquid developer according to the aspect of the invention may contain a phosphorus acid ester-based antioxidant in an amount of 0.01% to 5.0% by mass.

The liquid developer according to the aspect of the invention may contain at least any one of 2,6-di-t-butyl-4-methylphenol and 2,6-di-t-butyl-4-methoxyphenol, as the phenolic antioxidant.

According to another aspect of the invention, there is provided an image forming apparatus having a liquid developer which is developing an electrostatic latent image formed on an electrostatic latent image carrier. And the liquid developer contains a positively chargeable pigment, a carrier liquid having 30% to 80% by mass of triglyceridic linoleic acid component, and an antioxidant formed of a phosphorus acid ester compound.

The image forming apparatus have additionally a phenolic antioxidant in an amount of 0.05% by mass or more and 0.4% by mass or less.

For a positively chargeable liquid developer using a vegetable oil as the carrier liquid, when the contents of linoleic acid component (divalent unsaturated fatty acid) constituting the triglyceride of the vegetable oil are specified and a phosphorus acid ester is added to the liquid developer as an antioxidant, the antioxidant prevents alteration of the vegetable oil during storage, without deteriorating the positive charging properties of the liquid developer, and polymerization due to oxidative deterioration, or odor generation can be prevented over a long term. As a result, a liquid developer capable of forming images that are stable for a long time period can be provided.

### BRIEF DESCRIPTION OF THE DRAWINGS

The invention will be described with reference to the accompanying drawings, wherein like numbers reference like elements.

FIGS. 1A and 1B are diagrams illustrating a cell for measuring the charging properties of a pigment dispersed in a vegetable oil of the invention.

FIG. 2 is a diagram illustrating a liquid developing type image forming apparatus.

### DESCRIPTION OF EXEMPLARY EMBODIMENTS

The present invention is directed to a liquid developer for positive charging using a vegetable oil as the carrier liquid. When the carrier liquid having 30% to 80% by mass of a triglyceridic linoleic acid component is used and when a phosphorus acid ester is added as an antioxidant to a liquid developer, problems such as an increase in the viscosity during storage due to oxidative polymerization and the like can be solved without deteriorating the charging properties of the colorant particles, and also that the characteristics of the formed images, such as increased contrast and the like, are improved. The invention is also directed to the fixing properties of the transferred images are not deteriorated by the addition of an antioxidant.

The specific reason why the properties of images are improved upon the addition of phosphorous acid esters is not clear; however, it is conjectured that the addition of a phosphorous acid ester causes the pigment particles in the vegetable oil to attain adequate charging properties, thus enhancing the performance of the liquid developer of positive polarity.

As the vegetable oil that can be used as the carrier liquid of the liquid developer according to the embodiment of the invention, at least any one of corn oil, soybean oil, cottonseed oil, and safflower oil may be used.

Fat is an ester composed of one molecule of glycerin and three molecules of fatty acids, that is, a triglyceride, and it is known that when a triglyceride reacts with an alcohol or a fatty acid, trans-esterified oil can be obtained, with the properties of the raw material fat being modified. The vegetable oil to be used in the invention also includes trans-esterified oils prepared by trans-esterification involving vegetable oils as the raw material. The vegetable oil may be a single species or a mixture of plural species, and may also be a mixture of esters obtained from decomposition of vegetable oils.

In the case of using a mixture of plural species, it is desirable to adjust the kind and mixing amount of the vegetable oils to be mixed, in consideration of the image contrast, fixability and the like.

The fatty acid compositions (mass %) such as corn oil, soybean oil, cottonseed oil, and safflower oil are presented in Table 1.

TABLE 1

| | | | Cottonseed | Safflower |
|---|---|---|---|---|
| Fatty acid | Corn oil | Soybean oil | oil | oil |
| Palmitic acid | 7 to 13 | 5 to 12 | 20 to 30 | 4 to 8 |
| Stearic acid | 2 to 5 | 2 to 7 | 1 to 5 | 1 to 4 |
| Oleic acid | 25 to 45 | 20 to 35 | 15 to 30 | 8 to 25 |
| Linoleic acid | 40 to 60 | 50 to 57 | 40 to 60 | 60 to 80 |
| Linolenic | 0 to 3 | 3 to 8 | 0 to 1 | 0 to 1 |
| acid | | | | |

The liquid developer according to an embodiment of the invention contains triglyceride constituted with the linoleic acid (divalent unsaturated fatty acids) and thus oxidative polymerization is easily carried out so that the fixing device may be omitted or miniaturized.

The content of the linoleic acid component in the vegetable oil may be increased by adding a linoleic acid ester to the vegetable oil having less linoleic acid component. To the vegetable oil having much linoleic acid component, on the other hand, ester having less linoleic acid component may be added to adjust the amount of the linoleic acid component in the vegetable oil.

For instance, the vegetable oil having less linoleic acid component or transesterified oil based on thereof; and the vegetable oil having much linoleic acid component or transesterified oil based on thereof (e.g., soybean methyl ester) may be mixed to adjust easily the amount of the linoleic acid component in the vegetable oil. The mixing ratio can be determined by taking the image contrast and fixability into account.

In the case of improving the storability, it is more preferable to adjust the viscosity by adding an oleic acid methyl ester than to use the vegetable oil having much oleic acid of which triglyceride atom is a univalent fattyacid. This is also preferable in terms of the odor of the vegetable oil.

Therefore, the properties of carrier liquid of the liquid developer can be regulated by using the combination of the vegetable oil and the fatty acid ester derived thereof.

When the contents of triglyceride, which is constituted with the linoleic acid components in the carrier liquid of the liquid developer according to an embodiment of the invention, is less than 30% by mass, the fixability is deteriorated and when the contents of triglyceride is more than 80% by mass, the viscosity is increased, and it is not preferable.

The phosphorous acid ester-based antioxidant that is mixed into the liquid developer according to an embodiment of the invention, is preferably a phosphorous acid ester which is stably present in vegetable oils, preferably being in the liquid state within the operation region for the liquid developer. Specific examples of the phosphorous acid ester include triphenyl phosphite, trioleyl phosphite, diphenyl mono(2-ethylhexyl) phosphite, dilauryl hydrogen phosphite, diphenyl hydrogen phosphite, tetraphenyl tetra(tridecyl)pentaerythritol tetraphosphite, and tetra(C12-C15 alkyl) 4,4′-isopropylidenediphenyl phosphite.

Furthermore, the content of the phosphorous acid ester compound in the liquid developer is preferably 0.2% to 5.0% by mass when the phosphorous acid ester compound is the only compound in the liquid developer.

When the content is less than 0.2% by mass, the effects of improving the image contrast are small. When the content is greater than 5.0% by mass, the fixability is deteriorated.

In addition, in the case of using the phosphorous acid ester compounds and phenolic antioxidants in combination as the antioxidant, the content of the phosphorous acid ester compound in the liquid developer is preferably 0.01% to 5.0% by mass.

When the content is less than 0.01% by mass, the effects of improving the image contrast are small. When the content is more than 5.0% by mass, the fixability is deteriorated.

For the phenolic antioxidants added to the liquid developer according to the embodiment of the invention, the phenolic compounds are preferably that are stably present in vegetable oils.

Specific examples of the phenolic compounds include 2,6-di-t-butyl-4-methylphenol, 2,6-di-t-butyl-4-methoxy-phenol, 2,6-di-t-butylphenol, 2,6-di-t-butyl-4-ethylphenol, 2,4-dimethyl-6-t-butylphenol, 4,4′-methylene-bis(2,6-di-t-butylphenol), 4,4′-bis(2,6-di-t-butylphenol), 4,4′-bis(2-methyl-6-t-butylphenol), 2,2′-methylenebis(4-methyl-6-t-butylphenol), 2,2′-methylenebis(4-ethyl-6-t-butylphenol), 4,4′-butylidenebis(3-methyl-6-t-butylphenol), 4,4′-isopropylidenebis(2,6-di-t-butylphenol), 2,2′-methylenebis(4-methyl-6-cyclohexylphenol), 2,2′-methylenebis(4-methyl-6-nonylphenol), 2,2′-isobutylidenebis(4,6-dimethylphenol), 2,6-bis(2′-hydroxy-3′-t-butyl-5′-methylbenzyl)4-methylphenol, 3-t-butyl-4-hydroxyanisole, and 2-t-butyl-4-hydroxyanisole.

Furthermore, 3-(4-hydroxy-3,5-di-t-butylphenyl) stearyl propionate, 3-(4-hydroxy-3,5-di-t-butylphenyl) oleyl propionate, 3-(4-hydroxy-3,5-di-t-butylphenyl) dodecyl propionate, 3-(4-hydroxy-3,5-di-t-butylphenyl) decyl propionate, 3-(4-hydroxy-3,5-di-t-butylphenyl) octyl propionate, tetrakis{3-(4-hydroxy-3,5-di-t-butylphenyl) propionyloxymethyl}methane, 3-(4-hydroxy-3,5-di-t-butyl-phenyl) propionic acid glycerin monoester, ester of 3-(4-hydroxy-3,5-di-t-butylphenyl) propionic acid and glycerin monooleyl ether, 3-(4-hydroxy-3,5-di-t-butylphenyl) propionic acid butylene glycol ester, 3-(4-hydroxy-3,5-di-t-butylphenyl) propionic acid thiodiglycol ester, and the like may be included.

Also, 4,4′-thiobis(3-methyl-6-t-butylphenol), 4,4′-thiobis(2-methyl-6-t-butylphenol), 2,2′-thio-bis(4-methyl-6-t-butylphenol), 2,6-di-t-butyl-α-dimethyl-amino-4-methylphenol, 2,6-di-t-butyl-4-(N,N′-dimethyl-aminomethylphenol), bis(3,5-di-t-butyl-4-hydroxybenzyl) sulfide, tris{(3,5-di-t-butyl-4-hydroxy-phenyl)propionyloxyethyl} isocyanurate, tris(3,5-di-t-butyl-4-hydroxyphenyl) isocyanurate, 1,3,5-tris(3,5-di-t-butyl-4-hydroxybenzyl) isocyanurate, bis{2-methyl-4-(3-n-alkylthiopropionyloxy)-5-t-butyl-phenyl} sulfide, 1,3,5-tris(4-t-butyl-3-hydroxy-2,6-dimethylbenzyl) isocyanurate, tetraphthaloyl di(2,6-dimethyl-4-t-butyl-3-hydroxybenzylsulfide), 6-(4-hydroxy-3,5-di-t-butylanilino)-2,4-bis-(octylthio)-1,3,5-triazine, 2,2-thio-{diethyl-bis-3-(3,5-di-t-butyl-4-hydroxyphenyl)} propionate, N,N′-hexamethylene-bis(3,5-di-t-butyl-4-hydroxyhydrocinnamide), 3,5-di-t-butyl-4-hydroxy-benzyl-phosphoric acid diester, bis(3-methyl-4-hydroxy-5-t-butylbenzyl) sulfide, 3,9-bis[1,1-dimethyl-2-{β-(3-t-butyl-4-hydroxy-5-methylphenyl)propionyloxy}ethyl]-2,4,8,10-tetraoxapyro[5,5]undecane, 1,1,3-tris(2-methyl-4-hydroxy-5-t-butylphenyl)butane, 1,3,5-trimethyl-2,4,6-tris(3,5-di-t-butyl-4-hydroxybenzyl) benzene, bis{3,3′-bis-(4′-hydroxy-3′-t-butylphenyl)butyric acid} glycol ester, and the like may be included. Among these, 2,6-di-t-butyl-4-methylphenol (BHT), and 2,6-di-t-butyl-4-methoxyphenol (BHA) are preferred.

When the content of the phenolic antioxidant is less than 0.05% by mass, the effects of adding the phenolic antioxidant are small. When the content of the phenolic antioxidant is more than 0.4% by mass, the image contrast is deteriorated.

For the liquid developer according to the embodiment of the invention, a charge controlling agent, a resin and the like may be added, in addition to the pigment and the antioxidant of phosphorous acid ester. Specific examples of the charge controlling agent include tetraethyl titanate, tetraisopropyl titanate, tetra-n-propyl titanate, tetra-n-butyl titanate, tetra-tert-butyl titanate, tetra-2-ethylhexyl titanate, tetraoctyl titanate, tetramethoxytitanium and the like, or titanium chelates such as titanyl acetyl acetate and the like. Moreover, other examples thereof include titanate coupling agents, for example, isopropyl triisostearoyl titanate, isopropyl tridecylbenzenesulfonyl titanate, isopropyl tris(dioctylpyrophosphate) titanate, tetraisopropyl bis(dioctylphosphite) titanate, tetraoctyl bis(ditridecylphosphite) titanate, tetra(2,2-diallyloxidylmethyl1-butyl) bis(ditridecyl), bis(dioctylpyrophosphate) ethylene titanate, isopropyl trioctanoyl titanate, isopropyl dimethacryl isostearoyl titanate, isopropyl isostearoyl diacryl titanate, isopropyl tri(dioctylphosphate) titanate, isopropyl tricumylphenyl titanate, and isopropyl tri(N-aminoethyl-aminoethyl) titanate.

In addition, in the case of using a resin, one or two or more resins selected from ethylene/vinyl acetate copolymers, polyester resins, styrene/acrylic resins, rosin-modified resins, polyethylene, ethylene/acrylic acid copolymers, ethylene/maleic anhydride copolymers, polyvinylpyridine, polyvinylpyrrolidone, ethylene/methacrylic acid copolymers, and ethylene/acrylic acid ester copolymers, can be used.

For the liquid developer according to the embodiment of the invention, it is preferable that the primary particle size of colored microparticles is set to a particle size of 1 μm or less as the number average particle size, by mixing the vegetable oil, pigment and the like, and dispersing the mixture using an attriter, a sand mill, a ball mill, a vibration mill or the like.

Hereinafter, the method for measuring the charging properties of a pigment according to an embodiment of the invention will be described.

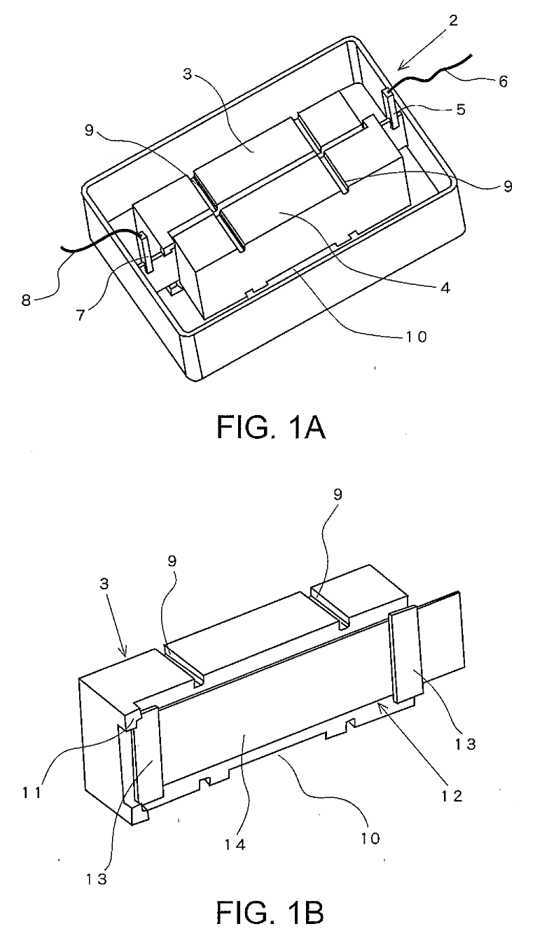

FIGS. 1A and 1B are diagrams illustrating a cell for measuring the charging properties of a pigment dispersed in a vegetable oil to be used in the invention, and FIG. 1A is a perspective view showing the measuring cell, while FIG. 1B is a perspective view showing the electrode unit.

The measuring cell 1 has an anode electrode unit 3 and a cathode electrode unit 4 installed in a container 2 which is formed from an electrically insulating member such as glass, synthetic resin or the like.

An anode terminal 5 provided in the anode electrode unit 3 is connected to an anode lead wire 6 for power feeding, which is bound to a current supply apparatus (not shown in the figure), while a cathode terminal 7 provided in the cathode electrode unit 4 is connected to a cathode lead wire 8 which is bound to a current supply apparatus (not shown in the figure).

The anode electrode unit 3 and the cathode electrode unit 4 are provided on the top with retention member mounting grooves 9 for the purpose of spacing the two electrode units at a predetermined interval, so that the two electrode units are spaced apart at a predetermined interval during the measurement by mounting retention members.

Furthermore, the anode electrode unit 3 and the cathode electrode unit 4 are provided with a channel groove 10 in the lower part, to allow smooth supplying of pigment dispersion.

Although FIG. 1B illustrates the anode electrode unit, the cathode electrode unit is also formed from the same structure and members.

The anode electrode unit 3 uses a molded body produced by providing projections for anode engagement 11 to a resin having high oil resistance and solvent resistance, such as polyacetal resin (POM).

The projections for anode engagement 11 have an anode 12 mounted together with spacers 13 formed from insulating members for the purpose of maintaining the anode 12 apart from the opposite electrode at a constant interval.

The anode 12 is preferably produced by forming on a transparent glass plate, a transparent conductive film 14 of ITO or the like, which, when a current is applied, does not leach due to the applied current. When an anode produced by forming a transparent conductive film on a transparent glass plate is used, it becomes possible to perform with ease the optical observation and measurement of the pigment deposited on the anode, which is removed from the anode electrode unit, after an electrophoresis performed by passing a current for a predetermined time.

Furthermore, after transferring the pigment by pressing the anode removed from the anode electrode unit onto a transfer member such as paper, synthetic resin film or the like, the pigment concentration may be measured using a reflective concentration meter or the like.

As a comparison is made for the pigment deposited on the anode and the cathode respectively, or for the images transferred therefrom, it can be determined as to whether the pigment has properties of being positively charged or negatively charged

Hereinafter, the invention will be described with reference to Examples of the invention.

### EXAMPLE 1-1

Preparation of Liquid Developer

In a stainless steel container having a capacity of 500 mL, 320 g of zirconium oxide balls with a diameter of 5 mm, 100 g of corn oil (the triglyceridic fatty acid composition in the corn oil manufactured by Nisshin Oillio Group, Ltd.; 11.3% by mass of the palmitic acid, 1.9% by mass of the stearic acid, 32.2% by mass of the oleic acid, 52.2% by mass of the linoleic acid, and 1.0% by mass of the linolenic acid), 0.11 g of a dispersant (Ajinomoto Fine-Techno Co., Inc.; Ajisper PA-111), 15 g of Pigment Blue 15:3, a positively chargeable pigment as a cyan pigment, and 4.17 g of each of the antioxidant indicated in Table 2 were mixed and dispersed using a stirrer (Chuo Rikaki Seisakusho, KK; Tornado SM type propeller stirring blade) at a rotation speed of 504 rpm for 11 hours, to prepare a colorant dispersion.

Diphenyl mono(2-ethylhexyl) phosphite as a phosphite ester was a transparent liquid, 4,4′-thiobis-(2-tert-butyl-5-methylphenol) was a white crystal having a melting point of 124° C., while dibutylhydroxytoluene was a colorless crystal having a melting point of 65° C.

Then, 5 g each of the obtained colorant dispersions was added to 30 g of the corn oil, and the mixture was sufficiently mixed. Thus, the liquid developers were obtained. A liquid developer containing no antioxidant was also prepared for a comparative data.

Evaluation of Charging Properties Via Electrophoresis

The charging behavior of the pigment dispersions was investigated using the above-described cell for measuring the charging properties, as shown in FIGS. 1A and 1B. A direct current voltage of 300 V was applied to the cell for measuring the charging properties, at an inter-electrode distance of 2 mm for 10 seconds, to attach colored microparticles to transparent electrodes of ITO via electrophoresis. The transparent electrodes of ITO were removed from the measuring cell, and the colored microparticles attached on the anode and the cathode were transferred by pressing on a transfer paper (Fuji Xerox Office Supply, Inc.; high-quality paper for PPC, J-paper) . Thus, the colored microparticles attached on the respective electrodes could be obtained as colored beta images on the transfer paper.

The concentrations of the colored beta images obtained were measured as reflective concentrations using a reflective concentration meter (X-Rite, Inc., Model 520 spectrometric concentration meter), after leaving the images to stand for 1 day. The amount attached on the electrode can be calculated from the reflective concentration value on the transfer paper. That is, when the reflective concentration at the cathode is greater than the reflective concentration at the anode, it can be evaluated that the pigment dispersed microparticles are positively charged, whereas when the reflective concentration at the anode is greater than the reflective concentration at the cathode, the pigment dispersed microparticles are negatively charged. Also, when the reflective concentrations at the anode and the cathode are the same, it can be evaluated that the pigment-dispersed microparticles are neutrally charged.

As discussed above, the reflective concentration values of the beta images transferred onto a transfer paper from the respective electrodes were determined, and the difference was indicated as the image contrast. It can be understood from the magnitude of the difference value as to whether the pigment-dispersed microparticles are sufficiently charged as a positively charged toner. The results of measurement thus determined are presented in Table 2.

TABLE 2

| Type of antioxidant | Image contrast |
|---|---|
| No addition | 0.61 |
| Diphenyl mono(2-ethylhexyl) phosphite | 0.71 |
| 4,4′-thiobis-(2-tert-butyl-5-methylphenol) | 0.56 |
| Dibutylhydroxytoluene | 0.55 |

According to the results in Table 2, when a phosphorous acid ester was added as an antioxidant, the image contrast was rather of a higher value than that of the case where no antioxidant was added. On the other hand, when 4,4′-thiobis-(2-tert-butyl-5-methylphenol) was added as a phenolic antioxidant, the image contrast was of a lower value than that of the case where no antioxidant was added, thus resulting in deterioration of the charging properties for the liquid developer. This is thought to be because, when a phosphorous acid ester is added, a suitable charging region is reached, thus enhancing the image contrast.

### EXAMPLE 1-2

Liquid developers were prepared in the same manner as in Example 1-1, except that a soybean oil (the triglyceridic fatty acid composition in the soybean oil manufactured by Nisshin Oillio Group, Ltd.; 10.6% by mass of the palmitic acid, 4.4% by mass of the stearic acid, 23.3% by mass of the oleic acid, 53.4% by mass of the linoleic acid, and 7.0% by mass of the linolenic acid) was used as the vegetable oil, and at the same time, the amount of phosphorous acid ester described in table 3 added to each of the liquid developers was 0.5% by mass. An evaluation of the charging behavior via electrophoresis was performed in the same manner as in Example 1-1, and the results are presented together with the phosphorus content, which represents the content of phosphorus in each of the phosphorous acid esters, expressed in % by mass.

TABLE 3

| | Phosphorus content | Image |
|---|---|---|
| Phosphorous acid ester | (mass %) | contrast |
| No addition | 0 | 0.58 |
| Triphenyl phosphite | 10.0 | 0.81 |
| Trioleyl phosphite | 3.7 | 0.59 |
| Dilauryl hydrogen phosphite | 6.5 | 0.70 |
| Diphenyl hydrogen phosphite | 13.2 | 0.73 |
| Diphenyl mono(2-ethylhexyl) phosphite | 8.6 | 0.85 |
| Tetra(C12-C15 alkyl) 4,4′- | 5.3 | 0.82 |
| isopropylidenediphenyl phosphite | | |
| Tetraphenyl tetra(tridecyl) | 8.7 | 0.82 |
| pentaerythritol tetraphosphite | | |

### EXAMPLE 1-3

Liquid developers were prepared in the same manner as in Example 1-1, except that soybean oil (the triglyceridic fatty acid composition in the soybean oil manufactured by Nisshin Oillio Group, Ltd.; 23.3% by mass of the oleic acid, 53.4% by mass of the linoleic acid, and 7.0% by mass of the linolenic acid) was used as the vegetable oil, and tetra (C12-C15 alkyl) 4,4′-isopropylidenediphenyl diphosphite was used as the phosphorous acid ester-based antioxidant, with the amount added being varied from 0.01 to 5.0% by mass.

The charging behavior at room temperature of each of the colorant dispersions was measured at 25° C. in the same manner as in Example 1-1, and the amount of phosphorous acid ester added (% by mass) and the image contrast are presented in Table 4.

Furthermore, an evaluation of the formed images was performed by an image evaluation test described below.

Image Evaluation Test

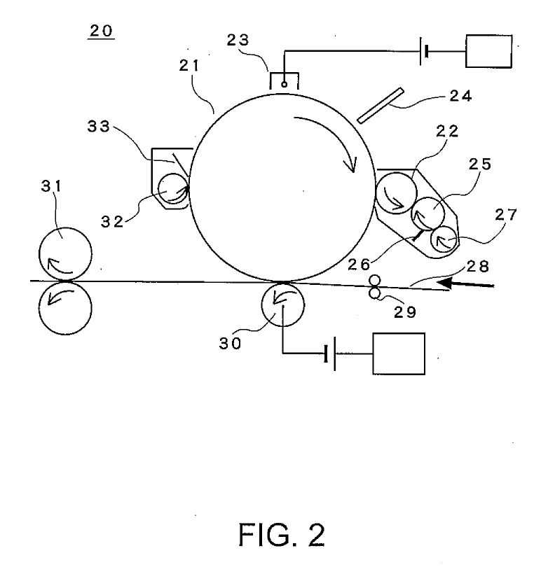

The processes of development, transfer, cleaning and fixation were performed using the prepared liquid developers and the liquid developing type image forming apparatus shown in FIG. 2.

In the image forming apparatus 20, a single-layer type, positively charged organic photosensitive member is used as a photosensitive member 21, and a developing roller 22 is formed of an elastic member. First, the surface of the photosensitive member 21 is charged to +650 V using a scorotron 23, and a laser light 24, which is controlled by image signals, is irradiated thereon to form a latent image. Then, a developing bias of +600 V is applied to the developing roller 22 to perform development. The developing roller 22 is supplied with a liquid developer having its layer thickness regulated by a regulating blade 26, and an anilox roller 25 rotates in the same direction with the developing roller 22 while being in contact therewith.

The anilox roller 25 is supplied with the liquid developer from a supply roller 27, which is a sponge-shaped elastic roller. The transfer bias is −950 V, and a transfer paper 28 is supplied as indicated by the arrow, by a pair of supply rollers 29 in synchronization with image transfer at a rate of 200 mm/second.

A transfer roller 30 is an elastic roller, and the transfer bias is applied thereto through a controller. The image transferred onto the transfer paper passes between heat fixing rollers 31, which are formed of an oil-repellant material, and is fixed. The fixing temperature is set to 90° C., and the degree of contact can be set such that a toner image developed and transferred from the transfer paper does not migrate to another member at the degree of contact.

In the case where residual toner remains after the transfer, the residual toner is removed by a cleaning blade 33 disposed in the upper part, while a cleaning elastic roller 32 being in contact with the photosensitive member transports the attached liquid developer from the photosensitive member. The cleaned photosensitive member again undergoes the cycle of charging, exposure, development, transfer and cleaning, thus to form a monochromic image.

A 5% coverage document and the beta image were printed out using a liquid developer and the image forming apparatus shown in FIG. 2. The size of the beta image was 20 mm×20 mm.

For an evaluation of the fixability, an adhesive tape (Sumitomo 3M, Ltd., mending tape) having a width of 12 mm was adhered on the printout formed on a transfer paper (Fuji Xerox Office Supply, Inc.; paper for PPC, J paper), pressed with a roller weighing 500 g in a 10-times shuttling movement, and peeled off. The concentration of the printout remaining on the transfer paper and the concentration before the peel-off were measured using a reflective concentration meter (X-Rite, Inc.), and the ratio of the concentration remaining to the concentration before the peel-off was determined, as expressed in percentage and indicated in Table 4.

TABLE 4

| Amount of phosphorous acid | | |
|---|---|---|
| ester added | Image contrast | Fixation ratio |
| No addition | 0.58 | 85% |
| 0.01% by mass | 0.53 | 85% |
| 0.1% by mass | 0.53 | 85% |
| 0.2% by mass | 0.60 | 85% |
| 0.3% by mass | 0.63 | 84% |
| 0.5% by mass | 0.82 | 84% |
| 2.0% by mass | 0.77 | 81% |
| 5.0% by mass | 0.68 | 80% |

According to the results obtained above, when the amount of the antioxidant added is more than 0.2% by mass, an increase in the image contrast is observed. If the amount exceeds 5.0% by mass, the fixation ratio is decreased to a larger extent. Therefore, the amount of addition of the antioxidant is preferably set to 0.2% to 5.0% by mass.

### EXAMPLE 1-4

In a stainless steel container having a capacity of 500 mL, 320 g of zirconium oxide balls having a diameter of 5 mm, 100 g each of the vegetable oils (all of which, by Nisshin Oillio Group, Inc.) indicated in Table 5, 15 g of benzimidazolone pigment P.R.185 as a positively chargeable pigment, and 0.23 g of a dispersant (Ajinomoto Fine-Techno Co., Inc.; Ajisper PN-411) were mixed and dispersed using a stirrer (Chuo Rikaki Seisakusho, KK; Tornado SM type propeller stirring blade) at a rotation speed of 504 rpm for 14 hours, to prepare a colorant dispersion.

Then, 5 g of the obtained colorant dispersion was added to 30 g each of the vegetable oils indicated in Table 5, and sufficiently mixed. 0.176 g (corresponding to 0.5% by mass in terms of the amount of addition) of triphenyl phosphite as the antioxidant was added and sufficiently mixed. Thus, 6 kinds of liquid developers were obtained.

Evaluations of the charging behavior, and the fixability by an image evaluation test were performed in the same manner as in Example 1-3, and the results are presented in Table 6 as fixation ratio.

According to the results, it can be seen that a vegetable oil having a high proportion of triglyceridic linoleic acid component tends to have a relatively higher image contrast. The fixation ratio was 83% to 84% in most of the cases, and large differences were not observed.

However, it was observed that a MO sunflower oil having a 29.7% by mass of the linoleic acid component have a slightly lower fixation ratio, which is 80%.

TABLE 5

| | | | | | MO |
|---|---|---|---|---|---|
| Fatty acid | | Soybean | Cottonseed | Safflower | sunflower |
| composition | Corn oil | oil | oil | oil | oil |
| Palmitic | 11.3% | 10.6% | 19.8% | 6.4% | 3.6% |
| acid | | | | | |
| Stearic | 1.9% | 4.4% | 2.4% | 2.2% | 3.6% |
| acid | | | | | |
| Oleic acid | 32.2% | 23.3% | 19.3% | 13.9% | 60.5% |
| Linoleic | 52.2% | 53.4% | 55.7% | 76.2% | 29.7% |
| acid | | | | | |
| Linolenic | 1.0% | 7.0% | 0.8% | 0.2% | 0.3% |
| acid | | | | | |

TABLE 6

| Type of vegetable oil | Image contrast | Fixation ratio |
|---|---|---|
| Corn oil | 0.85 | 83% |
| Soybean oil | 0.85 | 84% |
| Cottonseed oil | 0.84 | 83% |
| Safflower oil | 0.82 | 83% |
| MO sunflower oil | 0.85 | 80% |

### EXAMPLE 1-5

41 g of an safflower oil having triglyceridic fatty acid components in the vegetable oil as follows: 6.4% by mass of palmitic acid, 2.2% by mass of stearic acid, 13.9% by mass of oleic acid, 76.0% by mass of linoleic acid, and 0.2% by mass of linolenic acid; 59 g of linseed fatty acid methyl ester (Nisshin Oillio Group, Inc.); 15 g of benzimidazolone pigment P.R.185, a positively chargeable pigment; and 0.23 g of a dispersant (Ajinomoto Fine-Techno Co., Inc.; Ajisper PN-411) were used to prepare a colorant dispersion. The proportion of the triglyceridic linoleic acid component in the vegetable oil was 40% by mass.

Subsequently, 4.17 g of diphenyl mono (2-ethylhexyl) phosphite was added as the antioxidant to prepare a liquid developer in the same manner as the Example 1-1.

The processes of development, transfer, cleaning and fixation were performed in the same manner as in the method described in Example 1-3, using the obtained liquid developer and the liquid developing type image forming apparatus shown in FIG. 2.

The changes in the image quality and fixability of the obtained printout at 5% coverage over time were evaluated, and the results are presented in Table 7.

For an evaluation of the fixation ratio of the beta portion, the same procedure as the method described in Example 1-3 was performed, and then the initially printed image was stored in an irradiation environment of 730 Lux for 14 hours/day at 25° C. and a relative humidity of 50%, and after 6 months, the fixation ratio of the beta portion was measured again.

The liquid developer was also stored for 6 months under the same conditions, while being placed in a beaker without lid. Also, for a comparison, a liquid developer containing no antioxidant was prepared as a blank.

TABLE 7

| | Initial | | After 6 months | |
|---|---|---|---|---|
| Evaluation results | Blank | Invention | Blank | Invention |
| Dispersibility of | Good | Good | Solid-liquid | Good |
| liquid developer | | | phase separation | |
| 4-point font | Legible | Legible | Hardly legible | Legible |
| character | | | | |
| Fixability of beta | 86% | 86% | 91% | 98% |
| portion | | | | |

As such, the storability of the liquid developer according to the embodiment of the invention was good, so that 4-point font characters printed with a liquid developer after storage of 6 months were still legible. However, the liquid developer of the Comparative Example containing no phosphorous acid ester antioxidant underwent solid-liquid phase separation. When this was stirred and introduced into the developing unit of the image forming apparatus, and an image forming test was carried out, precipitation was observed. Further, the printing quality was deteriorated compared to the initial quality, and 4-point font characters were hardly legible. Although the fixability of the printed image was improved, this is thought to be a result of on-going oxidative polymerization of the vegetable oil which serves as the carrier of the developer.

### EXAMPLE 2-1

Preparation of Liquid Developer

In a stainless steel container having a capacity of 500 mL, 320 g of zirconium oxide balls with a diameter of 5 mm, 100 g of corn oil (the triglyceridic fatty acid composition in the corn oil manufactured by Nisshin Oillio Group, Ltd.; 11.3% by mass of the palmitic acid, 1.9% by mass of the stearic acid, 32.2% by mass of the oleic acid, 52.2% by mass of the linoleic acid, and 1.0% by mass of the linolenic acid) , 0.11 g of a dispersant (Ajinomoto Fine-Techno Co., Inc.; Ajisper PA-111), and 15 g of Pigment Blue 15:3, a positively chargeable pigment, as a cyan pigment, were mixed and dispersed using a stirrer (Chuo Rikaki Seisakusho, KK; Tornado SM type propeller stirring blade) at a rotation speed of 504 rpm for 11 hours, to prepare a colorant dispersion.

Then, 5 g of the obtained colorant dispersion in the 30 g of the corn oil, and diphenyl mono (2-ethylhexyl) phosphite as a phosphorous acid ester-based antioxidant and 2,6-di-t-butyl-4-methylphenol (BHT) as a phenolic antioxidant, respectively in the amount of mixing indicated in Table 8, were sufficiently mixed and dispersed in the corn oil, until the phenolic antioxidant dissolved. A liquid developer containing no antioxidant was also prepared as a blank.

Evaluation of Charging Properties Via Electrophoresis

The cell for measuring charging properties as previously shown in FIGS. 1A and 1B was used to examine the charging behavior of the pigment dispersion. A direct current voltage of 300 V was applied to the cell for measuring charging properties, at an inter-electrode distance of 2 mm for 10 seconds, to attach colored microparticles to transparent electrodes of ITO via electrophoresis. The transparent electrodes of ITO were removed from the measuring cell, and the colored microparticles attached on the anode and the cathode were transferred by pressing on a transfer paper (Fuji Xerox Office Supply, Inc.; high-quality paper for PPC, J-paper) Thus, the colored microparticles attached on the respective electrodes could be obtained as colored beta images on the transfer paper.

The concentrations of the obtained colored beta images were measured, after leaving the images to stand for 1 day, as reflective concentrations using a reflective concentration meter (X-Rite, Inc., Model 520 spectrometric concentration meter). The amount attached on the electrode can be calculated from the reflective concentration value on the transfer paper. That is, it can be determined that when the reflective concentration at the cathode is greater than the reflective concentration at the anode, the pigment-dispersed microparticles are positively charged, whereas when the reflective concentration at the anode is greater than the reflective concentration at the cathode, the pigment-dispersed microparticles are negatively charged. It can also be determined that when the reflective concentrations at the anode and the cathode are the same, the pigment dispersed microparticles are neutrally charged.

As discussed above, the reflective concentration values of the beta images transferred onto a transfer paper from the respective electrodes were determined, and the difference was indicated as the image contrast. It can be understood from the magnitude of the difference value as to whether the pigment dispersed microparticles are sufficiently charged as a positively charged toner. The results of measurement thus determined are presented in Table 8.

TABLE 8

| | Amount of antioxidant mixed | | |
|---|---|---|---|
| | (% by mass) | | |
| | Phosphorous acid | | |
| Sample No. | ester-based | Phenolic | Image contrast |
| 1 | No addition | No addition | 0.62 |
| 2 | 0.5 | 0 | 0.72 |
| 3 | 0 | 0.5 | 0.54 |
| 4 | 0 | 0.05 | 0.72 |
| 5 | 0.5 | 0.05 | 0.76 |
| 6 | 0 | 0.1 | 0.80 |
| 7 | 0.5 | 0.1 | 0.82 |
| 8 | 0 | 0.2 | 0.72 |
| 9 | 0.5 | 0.2 | 0.86 |
| 10 | 0 | 0.3 | 0.68 |
| 11 | 0.5 | 0.3 | 0.72 |
| 12 | 0 | 0.4 | 0.61 |
| 13 | 0.5 | 0.4 | 0.64 |
| 14 | 0.5 | 0.5 | 0.45 |

As shown by the results in Table 8, when a phosphorous acid ester-based antioxidant was added, the image contrast was of a higher value than that of the case where no antioxidant was added. On the other hand, when only a phenolic antioxidant was added in an amount of 0.4% by mass or more, the image contrast was decreased, compared with only the case where no antioxidant was added.

Furthermore, when a phenolic antioxidant was added in addition to a phosphorous acid ester-based antioxidant, the image contrast was further increased, compared with the case of adding the phosphorous acid ester-based antioxidant only.

Diphenyl mono(2-ethylhexyl) phosphite used as the phosphorous acid-based antioxidant is a transparent liquid, while 2,6-di-t-butyl-4-methylphenol (BHT) is a colorless crystal having a melting point of 65° C. However, it is thought that both antioxidants helped in allowing the colorant particles to reach a suitable charging region in the liquid developer, thus enhancing the image contrast.

### EXAMPLE 2-2

Liquid developers were prepared in the same manner as in Example 2-1, except that soybean oil (the triglyceridic fatty acid composition in the soybean oil manufactured by Nisshin Oillio Group, Ltd.; 10.6% by mass of the palmitic acid, 4.4% by mass of the stearic acid, 23.3% by mass of the oleic acid, 53.4% by mass of the linoleic acid, and 7.0% by mass of the linolenic acid) was used as the vegetable oil, and at the same time, the amount of the phosphorous acid ester indicated in Table 9, which was added to each of the liquid developers, was 0.5% by mass, and the amount of 2,6-di-t-butyl-4-methylphenol added as the phenolic antioxidant was 0.2% by mass. An evaluation of the charging behavior via electrophoresis was performed in the same manner as in Example 2-1, and the results are presented in Table 9 together with the phosphorus content, which represents the content of phosphorus in each of the phosphorous acid esters, expressed in % by mass.

Also, an evaluation of odor was performed via a sensory test according to the evaluation method described below, and the results are also presented in Table 9.

Evaluation Test for Odor by Sensory Test

A transparent glass container containing a liquid developer was sealed and stored to stand at 40° C. for 6 months. The odor of the stored liquid developer after 6 months was compared with that of a newly prepared liquid developer formed of the same composition. The evaluation of odor was performed as follows by ten evaluators in a sensory test.

Ten evaluators compared the odor of each of the newly prepared liquid developers and the liquid developers after the storage test, and graded the odor in 4 grades with the scores presented below. The weighted averages of the scores from the respective evaluators are presented in Table 9 as the results of the odor test.

0 point: No change at all, 1 point: Slight changes perceived, 2 points: Changes clearly perceived, 3 points: Completely changed, and strong odor perceived.

When the phosphorous acid ester according to the embodiment of the invention was added, the image contrast was of a higher value, as compared with the case of no addition. Also, there was a tendency that a phosphorous acid ester having a higher phosphorus content resulted in a greater image contrast.

The liquid developers having the phosphorous acid esters according to the embodiment of the invention added therein, all yielded weighted averages of 0.1 or 0.2, and can be said to have substantially no change in the odor.

TABLE 9

| | | | Odor |
|---|---|---|---|
| | Phosphorus | Image | test |
| Phosphorous acid ester | content (mass %) | contrast | result |
| No addition | 0 | 0.58 | 1.2 |
| Triphenyl phosphite | 10.0 | 0.80 | 0.2 |
| Trioleyl phosphite | 3.7 | 0.59 | 0.2 |
| Dilauryl hydrogen phosphite | 6.5 | 0.70 | 0.1 |
| Diphenyl hydrogen phosphite | 13.2 | 0.73 | 0.1 |
| Diphenyl mono(2-ethylhexyl) | 8.6 | 0.85 | 0.2 |
| phosphite | | | |
| Tetra(C12-C15 alkyl) 4,4′- | 5.3 | 0.81 | 0.2 |
| isopropylidenediphenyl phosphite | | | |
| Tetraphenyl tetra(tridecyl) | 8.7 | 0.82 | 0.2 |
| pentaerythritol tetraphosphite | | | |

### EXAMPLE 2-3

Liquid developers were prepared in the same manner as in Example 2-1, except that soybean oil (the triglyceridic fatty acid composition in the soybean oil manufactured by Nisshin Oillio Group, Ltd.; 23.3% by mass of the oleic acid, 53.4% by mass of the linoleic acid, and 7.0% by mass of the. linolenic acid) was used as the vegetable oil, and tetra (C12-C15 alkyl) 4,4′-isopropylidenediphenyl diphosphite was used as the phosphorous acid ester-based antioxidant, with the amount added being varied from 0.01 to 5.0% by mass, and also at the same time, the amount of 2,6-di-t-butyl-4-methylphenol added to each of the liquid developers was 0.2% by mass.

The charging behavior at room temperature of each of the colorant dispersions was measured at 25° C. in the same manner as in Example 2-1, and the amount of phosphorous acid ester added (% by mass) and the image contrast are presented in Table 10.

Furthermore, an evaluation test of the formed images was performed by the same image evaluation test as the method described in Example 1-3, and the results are presented in Table 10.

TABLE 10

| Amount of phosphorous | | |
|---|---|---|
| acid ester added | Image contrast | Fixation ratio |
| No addition | 0.66 | 85% |
| 0.01% by mass | 0.69 | 85% |
| 0.1% by mass | 0.73 | 85% |
| 0.3% by mass | 0.88 | 84% |
| 0.5% by mass | 0.92 | 84% |
| 2.0% by mass | 0.90 | 81% |
| 3.0% by mass | 0.83 | 80% |
| 4.0% by mass | 0.71 | 80% |
| 5.0% by mass | 0.59 | 79% |

According to the results obtained above, the image contrast was increased with an increase in the amount of the phosphorous acid ester-based antioxidant added, but was decreased when the amount was 5.0% by mass. Meanwhile, the fixation ratio was gradually decreased with the addition of the antioxidant. The fixation ratio showed substantially no change up to the amount of 0.5% by mass, but after 5% by mass, the fixation ratio was greatly decreased. Therefore, the amount of addition of the phosphorous acid ester-based antioxidant is preferably set to less than 5% by mass.

### EXAMPLE 2-4

In a stainless steel container having a capacity of 500 mL, 320 g of zirconium oxide balls having a diameter of 5 mm, 100 g of 6 types of the vegetable oils containing mixed oil (mixed of 5 types of vegetable oils (all of which, by Nisshin Oillion Group, Inc.) of which the content of the triglyceridic fatty acid component is indicated in Table 11; and 77.8 parts by mass of the MO sunflower oil and 22.2 parts by mass of the safflower oil indicated in Table 11) having 40% by mass of the triglyceridic linoleic acid component, 15 g of benzimidazolone pigment P.R.185 as a positively chargeable pigment, and 0.23 g of a dispersant (Ajinomoto Fine-Techno Co., Inc.; Ajisper PN-411) were mixed and dispersed using a stirrer (Chuo Rikaki Seisakusho, KK; Tornado SM type propeller stirring blade) at a rotation speed of 504 rpm for 14 hours, to prepare colorant dispersions.

Then, 5 g of the obtained 6 types of colorant dispersions were added to 30 g of each of the same vegetable oils used for the preparation of the colorant dispersions, and sufficiently mixed. 0.176 g (corresponding to 0.5% by mass in terms of the amount of addition) of triphenyl phosphite as a phosphorous acid ester-based antioxidant, and 0.07 g (corresponding to 0.2% by mass in terms of the amount of addition) of 2,6-di-t-butyl-4-methoxyphenol as a phenolic antioxidant were added and sufficiently mixed. Thus, 6 kinds of liquid developers were obtained.

Evaluations of the charging behavior, and the fixability by an image evaluation test were performed in the same manner as in Example 2-3, and the results are presented in Table 11 as fixation ratio.

According to the results, large differences among the triglyceridic linoleic acid component were not observed in the vegetable oils used in the present invention. It can be seen that a vegetable oil having a high proportion of triglyceridic oleic acid component tends to have a relatively higher image contrast. The fixation ratio was more or less 80% in most of the cases, and large differences were not observed. However, it was observed that a MO sunflower oil having 29.7% by mass of the linoleic acid component have 80% of fixation ratio which is 3% to 4% lower than others.

TABLE 11

| | Content of | | |
|---|---|---|---|
| Type of vegetable | linoleic acid | | |
| oil | (mass %) | Image contrast | Fixation ratio |
| Corn oil | 52.2 | 0.90 | 83% |
| Soybean oil | 53.4 | 0.90 | 84% |
| Cottonseed oil | 55.7 | 0.89 | 83% |
| Safflower oil | 76.0 | 0.88 | 83% |
| Mixed oil | 40.0 | 0.90 | 83% |
| MO sunflower oil | 29.7 | 0.90 | 80% |

### EXAMPLE 2-5

41 g of an safflower oil having triglyceridic fatty acid components in the vegetable oil as follows: 6.4% by mass of palmitic acid, 2.2% by mass of stearic acid, 13.9% by mass of oleic acid, 76.0% by mass of linoleic acid, and 0.2% by mass of linolenic acid; 59 g of linseed fatty acid methyl ester (Nisshin Oillio Group, Inc.), 15 g of benzimidazolone pigment P.R.185, a positively chargeable pigment, and 0.23 g of a dispersant (Ajinomoto Fine-Techno Co., Inc.; Ajisper PN-411) were used to prepare a colorant dispersion. The proportion of the triglyceridic linoleic acid component in the vegetable oil was 40% by mass.

Subsequently, a liquid developer containing 0.5% by mass of diphenyl mono (2-ethylhexyl) phosphite as a phosphorous acid ester-based antioxidant and 0.2% by mass of 2, 6-di-t-butyl-4-methoxyphenol as a phenolic antioxidant was prepared.

The processes of development, transfer, cleaning and fixation were performed in the same manner as in the method described in Example 1-3, using the obtained liquid developer and the liquid developing type image forming apparatus shown in FIG. 2.

The changes in the image quality and fixability of the obtained printout at 5% coverage over time were evaluated, and the results are presented in Table 12.

For an evaluation of the fixation ratio of the beta portion, the same procedure as the method described in Example 1-3 was performed, and then the initially printed image was stored in an irradiation environment of 730 Lux for 14 hours/day at 25° C. and a relative humidity of 50%, and after 6 months, the fixation ratio of the beta portion was measured again.

The liquid developer was also stored for 6 months under the same conditions, while being placed in a beaker without lid. Also, for a comparison, a liquid developer containing no antioxidant was prepared as a blank.

TABLE 12

| Evaluation | Initial | | After 6 months | |
|---|---|---|---|---|
| results | Blank | Invention | Blank | Invention |
| Dispersibility | Good | Good | Solid-liquid | Good |
| of liquid | | | phase | |
| developer | | | separation | |
| 4-point font | Legible | Legible | Hardly | Legible |
| character | | | legible | |
| Fixability of | 86% | 86% | 91% | 98% |
| beta portion | | | | |

As such, the storability of the liquid developer according to the embodiment of the invention was good, so that 4-point font characters printed with a liquid developer after storage of 6 months were still legible. However, the liquid developer of the Comparative Example containing no phosphorous acid ester-based antioxidant and no phenolic antioxidant underwent solid-liquid phase separation. When this was stirred and introduced into the developing unit of the image forming apparatus, and an image forming test was carried out, precipitation was observed. Further, the printing quality was deteriorated compared to the initial quality, and 4-point font characters were hardly legible. Although the fixability of the printed images was improved, this is thought to be a result of on-going oxidative polymerization of the vegetable oil which serves as the carrier of the developer.

The liquid developer according to an embodiment of the invention was prepared by mixing the liquid developer containing the vegetable oil having 30% to 80% by mass of triglyceridic linoleid acid component in the carrier liquid and the antioxidant such as the phosphorous acid ester-based antioxidant or the phenolic antioxidant. Therefore, the positive charging properties of the colorants are not deteriorated and the liquid developer can have good storage stability. Further the function as the liquid developer can be performed for a long time and the liquid developer having good developing properties of the formed image and good fixability can be provided.

What is claimed is:

1. A liquid developer comprising:
a vegetable oil,
a positively chargeable pigment, and
a phosphorous acid ester compound,
wherein the vegetable oil contains 30% to 80% by mass of triglyceridic linoleic acid component.

2. The liquid developer according to claim 1, wherein the vegetable oil is at least any one selected from corn oil, soybean oil, cottonseed oil, and safflower oil.

3. The liquid developer according to claim 1, further comprising the phosphorous acid ester compound in an amount of 0.2% to 5.0% by mass

4. The liquid developer according to claim 1, wherein the phosphorous acid ester compound is at least any one of triphenyl phosphite, trioleyl phosphite, diphenyl mono(2-ethylhexyl) phosphite, dilauryl hydrogen phosphite, diphenyl hydrogen phosphite, tetraphenyl tetra(tridecyl) pentaerythritol tetraphosphite, and tetra(C12-C15 alkyl) 4,4′-isopropylidenediphenyl phosphite.

5. The liquid developer according to claim 1, further comprising 0.05% by mass or more and 0.4% by mass or less of a phenolic antioxidant.

6. The liquid developer according to claim 5, wherein the phenolic antioxidant is at least any one selected from 2,6-di-t-butyl-4-methylphenol or 2,6-di-t-butyl-4-methoxyphenol.

7. An image forming apparatus comprising a liquid developer as the developer for developing an electrostatic latent image formed on an electrostatic latent image carrier, wherein the liquid developer containing a positively chargeable pigment, a vegetable oil having 30% to 80% by mass of triglyceridic linoleic acid component, and a phosphorous acid ester compound.

8. The image forming apparatus according to claim 7, further comprising 0.05% by mass or more and 0.4% by mass or less of a phenolic antioxidant.
